(19) United States
(12) Patent Application Publication
(10) Pub. No.: US 2012/0083560 A1
(43) Pub. Date: Apr. 5, 2012

(54) BIO-BASED MATERIAL COMPOSITION AND OPTICAL DEVICE EMPLOYING THE SAME

(75) Inventors: Cheng-Hsuan Lin, Changhua County (TW); Chun-Hsiang Wen, Hsinchu (TW); HsunYu Lee, Taichung (TW); Yao-Chu Chung, Kaohsiung (TW); Chun-Hsiung Liao, Xindian City (TW); Shu-Chen Li, Xinzhuang City (TW); Hsiu-Yu Cheng, Hsinchu (TW); Guang-Way Jang, Hsinchu (TW)

(73) Assignee: INDUSTRIAL TECHNOLOGY RESEARCH INSTITUTE, Hsinchu County (TW)

(21) Appl. No.: 13/013,787

(22) Filed: Jan. 25, 2011

(30) Foreign Application Priority Data
Oct. 5, 2010 (TW) 099133826

(51) Int. Cl. C08L 67/04; C08K 5/20; C08L 33/12; C08K 3/30; C08K 3/22; C08K 5/521; C08K 5/5415

(52) U.S. Cl. 524/147; 524/601; 524/226; 524/210; 524/539; 524/267; 524/423; 524/430; 524/502

(57) ABSTRACT

The invention provides a bio-based material composition and an optical device employing the same. The composition can be a petroleum resin-free composition, including a polylactic acid resin, a filler, and a light diffusion agent. Further, the composition can be a composition with petroleum resin, including a polylactic acid resin, a petroleum resin, a light diffusion agent, and an antioxidant.

### CROSS REFERENCE TO RELATED APPLICATIONS

This application is based upon and claims the benefit of priority from the prior Taiwan Patent Application No. 099133826, filed on Oct. 5, 2010, the entire contents of which are incorporated herein by reference.

### BACKGROUND

1. Technical Field

The disclosure relates to a light diffusion composition and the optical device employing the same, and in particular relates to a bio-based light diffusion composition and the optical device employing the same.

2. Description of the Related Art

Thermoplastic resins have excellent heat resistance, mechanical properties, impact resistance and dimensional stability and are widely used in fields such as the office automation equipment field, automobile field and electric/electronic part field. On the other hand, however, most raw materials of thermoplastic resins originate from oil resources. In recent years, due to the fear that oil resources will someday be exhausted and push to decrease carbon dioxide in the atmosphere, which causes global warming, carbon-neutral biomass resources that do not originate from oil resources, which are used as raw materials and do not emit carbon dioxide after being combusted, have garnered great attention. Even in the field of polymers, biomass plastics produced from biomass resources have been ardently developed.

A representative examples of a biomass plastic is polylactic acid, and use thereof has increasingly expanded to dishes, packaging materials, miscellaneous goods and the like, because of its relatively high heat resistance and good mechanical properties.

However, polylactic acid is usually amorphous, and has inferior heat resistance. Therefore, it is not suitable for use under high temperatures, for example, of more than 50° C. The mechanical and heat resistance properties of polylactic acids are below standard, when applied as industrial material in fields in which thermoplastic resins are used. Further, the polylactic acids have significantly low hydrolysis resistance when used under wet and hot conditions because of their biodegradability.

Therefore, it is desirable to provide a polylactic acid based material with improved light diffusion, mechanical, and heat resistant properties.

### SUMMARY

An exemplary embodiment of a bio-based material composition, without petroleum resin, includes 90-99.9 parts by weight of polylactic acid resin, 0.1-10 parts by weight of a filler, and 0.1-10 parts by weight of a light diffusion agent.

Further, the disclosure also provides a bio-based material composition including 1-50 parts by weight of polylactic acid resin, 50-99 parts by weight of petroleum resin, 0.1-3 parts by weight of an antioxidant, and 0.1-5 parts by weight of a light diffusion agent.

The disclosure also provides an optical device, including a light diffusion element. Particularly, the light diffusion element can be made by the aforementioned bio-based material composition.

A detailed description is given in the following embodiments with reference to the accompanying drawings.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

The disclosure provides bio-based material compositions and a light diffusion element made by the bio-based material compositions. The obtained light diffusion element can be further applied in an optical device (such as back light module, display device, or luminaries) to improve illuminance uniformity.

Since the bio-based material composition of the disclosure employs the biomass resin (i.e. polylactic acid resin), a molded article made thereby has more environmentally friendly characteristics in comparison with an article consisting of petroleum resin. Further, a molded article made by the bio-based material composition of the disclosure exhibits high heat deflection temperature (HDT) and improved processability.

According to an embodiment of the disclosure, the bio-based material composition without petroleum resin can include 90-99.9 parts by weight of polylactic acid resin, 0.1-10 parts by weight of a filler, and 0.1-10 parts by weight of a light diffusion agent. The polylactic acid resin can have a molecular weight of between 70000-120000, and the filler can be silica.

The light diffusion agent can be organic or inorganic powders having a refractive index of between 1.4-2.7 and an average grain size of between 0.1-30 μm, such as polystyrene, co-poly (methyl methacrylate-styrene), polymethylsilsesquioxane, silicone, BaSO₄, Al₂O₃, TiO₂, or combinations thereof.

Further, the bio-based material composition can further include 0.1-10 parts by weight of a crystal nucleus agent. The crystal nucleus agent can include aromatic phosphoric acid ester, aromatic amide ester, aliphatic amide, maleic anhydride grafted (MAH) polymer, anhydride modified polyethylene, thermoplastic polyolefin elastomer, or combinations thereof, such as CH-50, GR205, GM613-05, MB226DY, POE, Ciba-287, NA-11, NA-32, or C-223A.

According to another embodiment, the disclosure also provides a bio-based material composition including 1-50 parts by weight of polylactic acid resin, 50-99 parts by weight of petroleum resin, 0.1-3 parts by weight of an antioxidant, and 0.1-5 parts by weight of a light diffusion agent. It should be noted that the molded article made by the composition including the mixture of polylactic acid resin and petroleum resin has high mechanical strength and yellowing resistance.

The light diffusion agent has the same definitions as above. The antioxidant can include phenol antioxidant, phosphorus-containing antioxidant, sulfur-containing antioxidant, amine antioxidant, or combinations thereof. The petroleum resin has a molecular weight of between 90000-170000, such as: polymethyl methacrylate (PMMA), poly(ethylene terephthalate) (PET), or polyacrylonitrile (PAN), preferably PMMA. The weight ratio between polylactic acid resin and petroleum resin is between 1:4 to 4:1.

The method for fabricating the bio-based article from the bio-based material composition without petroleum resin includes the following steps. First, a petroleum resinbio-based material composition is prepared by mixing a polylactic acid resin, a crystal nucleus agent, and a light diffusion agent together. Next, the bio-based material composition is added into the feed of a single or twin screw extruder under a temperature of 150-230° C. to form a sheet, a film, or a plate of material. Finally, the extruded material is disposed into a metal mold, and than is heated to undergo crystallization at a temperature of 80° C.-160° C. under vacuum. The mold surface temperature is set between 70° C.-140° C., and the crystallization is conducted for a period of between 4-50 periods. The optical properties (including transparence, haze, and diffusion rate) of the molded film (with a thickness of 2 mm) were measured.

Further, the method for fabricating the bio-based article from the bio-based material composition with petroleum resin includes the following steps. First, the polylactic acid resin (resin A), petroleum resin (resin B), antioxidant, and light diffusion agent were blended to prepare a composition, wherein the weight ratio between the polylactic acid resin and petroleum resin (the weight ratio of resin A/resin B) can be 25/75-75/25. The antioxidant had a weight percent of between 0.1-10 wt %, and the light diffusion agent had a weight percent of 0.1-10 wt %, based on the weight of the composition.

Next, the composition was added into the feed of a single or twin screw extruder under a temperature of 200-260° C. to form a plurality of grains. Finally, the extruded material was disposed into a metal mold, and than heated to undergo crystallization under vacuum. The optical properties (including transparence, haze, and diffusion rate) of the molded film (with a thickness of 2 mm) were measured.

The transparency and haze were measured according to an ASTM D1003 with a turbidimeter (NDH 2000, produced by NIPPON DENSHOKU INDUSTRIES CO, LTD), and the diffusion rate was measured by a GC-5000L (manufactured by Nippon Denshoku Kogyo) from a 0 to 180 diffusion angle.

The following experiments are intended to illustrate the invention more fully without limiting their scope, since numerous modifications and variations will be apparent to those skilled in this art. The general disclosure of the reagents and instruments used in the experiments are described below:

Polylactic acid resin (PLA): manufactured and sold by Nature Work under the trade No. NCP001.

Silica: prepared by sol-gel process and having a grain size of between 20 nm-10 μm.

Twin screw extruder: manufactured and sold by Coperion under the trade No. ZSK26, and having an inner diameter of 26 mm.

Injection molding machine: having a trade No. of MINI-1000.

Differential Scanning calorimeter (DSC): having a trade No. of TA-Q100.

Poly(methyl methacrylate) (PMMA): manufactured and sold by Chimei under the trade No. of CM205.

Antioxidant: manufactured and sold by Ciba under the trade Nos. of an antioxidant 1010 and Antioxidant 168.

Polystyrene light diffusion agent: manufactured and sold by Sekisui under the trade No. of SBX-6 and having a grain size of between 2-8 μm.

Silicone light diffusion agent: manufactured and sold by GANZ under the trade No. of SI-020, and having a grain size of between 1-5 μm.

TiO₂ light diffusion agent: manufactured and sold by Dupont under the trade No. of R706, and having a grain size of between 0.3-2 μm.

### Example 1

9.2 g of polylactic acid resin, 1.8 g of silica (with a grain size of 40 nm), and 0.1 g of a polystyrene light diffusion agent were mixed together The mixture was added into the feed of the twin screw extruder to perform a blending process at a temperature of 180° C. The result was molded to obtain the bio-based light diffusion film (1). The optical properties (including transparence, haze, and diffusion rate) of the light diffusion film (1) were measured and are shown in Table 1.

### Example 2

9.9 g of polylactic acid resin, 0.1 g of silica (with a grain size of 40 nm), and 0.3 g of a polystyrene light diffusion agent were mixed together The mixture was added into the feed of the twin screw extruder to perform a blending process at a temperature of 180° C. The result was molded to obtain the bio-based light diffusion film (2). The optical properties (including transparence, haze, and diffusion rate) of the light diffusion film (2) were measured and are shown in Table 1.

### Example 3

9.7 g of polylactic acid resin, 0.3 g of silica (with a grain size of 10 nm), 0.3 g of a crystal nucleus agent (Ciba-287), and 0.1 g of a polystyrene light diffusion agent were mixed together The mixture was added into the feed of the twin screw extruder to perform a blending process at a temperature of 180° C. The result was molded to obtain the bio-based light diffusion film (3). The optical properties (including transparence, haze, and diffusion rate) of the light diffusion film (3) were measured and are shown in Table 1.

### Example 4

9.7 g of polylactic acid resin, 0.3 g of silica (with a grain size of 40 nm), 0.3 g of a crystal nucleus agent (CH-50), and 0.1 g of a polystyrene light diffusion agent were mixed together The mixture was added into the feed of the twin screw extruder to perform a blending process at a temperature of 180° C. The result was molded to obtain the bio-based light diffusion film (4). The optical properties (including transparence, haze, and diffusion rate) of the light diffusion film (4) were measured and are shown in Table 1.

### Comparative Example 1

9.9 g of polylactic acid resin, and 0.1 g of silica (with a grain size of 10 nm) were mixed (in the absence of a crystal nucleus agent and light diffusion agent). The mixture was added into the feed of the twin screw extruder to perform a blending process at a temperature of 180° C. The result was molded to obtain the bio-based light diffusion film (5). The optical properties (including transparence, haze, and diffusion rate) of the light diffusion film (5) were measured and are shown in Table 1.

TABLE 1

| | | | | | Compara- |
|---|---|---|---|---|---|
| | | | | | tive |
| | Example | Example | | | Example |
| | 1 | 2 | Example 3 | Example 4 | 1 |
| polyactic acid | 9.2 | 9.9 | 9.7 | 9.7 | 9.9 |
| resin (g) | | | | | |
| Silica (g) | 1.8 | 0.1 | 0.3 | 0.3 | 0.1 |
| crystal nucleus | | | 0.3 | 0.3 | |
| agent (g) | | | (Ciba-287) | (CH-50) | |
| light diffusion | 0.1 | 0.3 | 0.1 | 0.1 | |
| agent (g) | | | | | |
| transparence % | 61.6 | 41.1 | 40.6 | 32.9 | 77.48 |
| haze % | 97.6 | 99.2 | 98.8 | 99.2 | 99.11 |
| diffusion rate % | 82.99 | 96.2 | 98.89 | 98.32 | 49.72 |

As shown in Table 1, the light diffusion film made by the composition of the disclosure (in the presence of a crystal nucleus agent and light diffusion agent) had diffusion rates which were two times larger than that of the light diffusion film made by the composition in the absence of a crystal nucleus agent and light diffusion agent.

### Example 5

Polylactic acid resin and poly(methyl methacrylate) were mixed, wherein the weight ratio between the polylactic acid resin and the poly(methyl methacrylate) was 1:3. Next, 1 wt % of a polystyrene light diffusion agent (based on the weight of the PLA/PMMA mixture) was added into the mixture. The result was added into the feed of the twin screw extruder to perform a blending process at a temperature of 230° C., and then molded by the injection molding machine to obtain the light diffusion film (6) with a thickness of 2 mm. The optical properties (including transparence, haze, and diffusion rate) of the light diffusion film (6) were measured and are shown in Table 2.

### Example 6

Polylactic acid resin and poly(methyl methacrylate) were mixed, wherein the weight ratio between the polylactic acid resin and the poly(methyl methacrylate) was 1:3. Next, lwt % of an antioxidant (Antioxidant 1010) and 2 wt % of a polystyrene light diffusion agent (based on the weight of the PLA/PMMA mixture) were added into the mixture. The result was added into the feed of the twin screw extruder to perform a blending process at a temperature of 230° C., and then molded by the injection molding machine to obtain the light diffusion film (7) with a thickness of 2 mm. The optical properties (including transparence, haze, and diffusion rate) of the light diffusion film (7) were measured and are shown in Table 2.

### Example 7

Polylactic acid resin and poly(methyl methacrylate) were mixed, wherein the weight ratio between the polylactic acid resin and the poly(methyl methacrylate) was 1:3. Next, lwt % of an antioxidant (Antioxidant 1010) and 3 wt % of a polystyrene light diffusion agent (based on the weight of the PLA/PMMA mixture) were added into the mixture. The result was added into the feed of the twin screw extruder to perform a blending process at a temperature of 230° C., and then molded by the injection molding machine to obtain the light diffusion film (8) with a thickness of 2 mm. The optical properties (including transparence, haze, and diffusion rate) of the light diffusion film (8) were measured and are shown in Table 2.

### Example 8

Polylactic acid resin and poly(methyl methacrylate) were mixed, wherein the weight ratio between the polylactic acid resin and the poly(methyl methacrylate) was 1:3. Next, lwt % of an antioxidant (Antioxidant 1010) and 4 wt % of silicone light diffusion agent (based on the weight of the PLA/PMMA mixture) were added into the mixture. The result was added into the feed of the twin screw extruder to perform a blending process at a temperature of 230° C., and then molded by the injection molding machine to obtain the light diffusion film (9) with a thickness of 2 mm. The optical properties (including transparence, haze, and diffusion rate) of the light diffusion film (9) were measured and are shown in Table 2.

### Example 9

Polylactic acid resin and poly(methyl methacrylate) were mixed, wherein the weight ratio between the polylactic acid resin and the poly(methyl methacrylate) was 1:3. Next, lwt % of an antioxidant (Antioxidant 1010) and 0.5 wt % of TiO2 light diffusion agent (based on the weight of the PLA/PMMA mixture) were added into the mixture. The result was added into the feed of the twin screw extruder to perform a blending process at a temperature of 230° C., and then molded by the injection molding machine to obtain the light diffusion film (10) with a thickness of 2 mm. The optical properties (including transparence, haze, and diffusion rate) of the light diffusion film (10) were measured and are shown in Table 2.

### Comparative Example 2

Polylactic acid resin and poly(methyl methacrylate) were mixed, wherein the weight ratio between the polylactic acid resin and the poly(methyl methacrylate) was 3:7. The mixture was added into the feed of the twin screw extruder to perform a blending process at a temperature of 230° C., and then molded by the injection molding machine to obtain the light diffusion film (11) with a thickness of 2 mm. The optical properties (including transparence, haze, and diffusion rate) of the light diffusion film (11) were measured and are shown in Table 2.

### Comparative Example 3

Polylactic acid resin and poly(methyl methacrylate) were mixed, wherein the weight ratio between the polylactic acid resin and the poly(methyl methacrylate) was 5:5. The mixture was added into the feed of the twin screw extruder to perform a blending process at a temperature of 230° C., and then molded by the injection molding machine to obtain the light diffusion film (12) with a thickness of 2 mm. The optical properties (including transparence, haze, and diffusion rate) of the light diffusion film (12) were measured and are shown in Table 2.

### Comparative Example 4

Polylactic acid resin and poly(methyl methacrylate) were mixed, wherein the weight ratio between the polylactic acid resin and the poly(methyl methacrylate) was 7:3. The mixture was added into the feed of the twin screw extruder to perform a blending process at a temperature of 230° C., and then molded by the injection molding machine to obtain the light diffusion film (13) with a thickness of 2 mm. The optical properties (including transparence, haze, and diffusion rate) of the light diffusion film (13) were measured and are shown in Table 2.

### Comparative Example 5

Polylactic acid resin and poly(methyl methacrylate) were mixed, wherein the weight ratio between the polylactic acid resin and the poly(methyl methacrylate) was 1:3. The mixture was added into the feed of the twin screw extruder to perform a blending process at a temperature of 230° C., and then molded by the injection molding machine to obtain the light diffusion film (14) with a thickness of 2 mm. The optical properties (including transparence, haze, and diffusion rate) of the light diffusion film (14) were measured and are shown in Table 2.

### Comparative Example 6

Polylactic acid resin and poly(methyl methacrylate) were mixed, wherein the weight ratio between the polylactic acid resin and the poly(methyl methacrylate) was 1:3. Next, 0.2 wt % of an antioxidant (Antioxidant 1010) (based on the weight of the PLA/PMMA mixture) was added into the mixture. The result was added into the feed of the twin screw extruder to perform a blending process at a temperature of 230° C., and then molded by the injection molding machine to obtain the light diffusion film (15) with a thickness of 2 mm. The optical properties (including transparence, haze, and diffusion rate) of the light diffusion film (15) were measured and are shown in Table 2.

### Comparative Example 7

Polylactic acid resin and poly(methyl methacrylate) were mixed, wherein the weight ratio between the polylactic acid resin and the poly(methyl methacrylate) was 1:3. Next, 0.6 wt % of an antioxidant (Antioxidant 1010) (based on the weight of the PLA/PMMA mixture) was added into the mixture. The result was added into the feed of the twin screw extruder to perform a blending process at a temperature of 230° C., and then molded by the injection molding machine to obtain the light diffusion film (16) with a thickness of 2 mm. The optical properties (including transparence, haze, and diffusion rate) of the light diffusion film (16) were measured and are shown in Table 2.

### Comparative Example 8

Polylactic acid resin and poly(methyl methacrylate) were mixed, wherein the weight ratio between the polylactic acid resin and the poly(methyl methacrylate) was 1:3. Next, 1 wt % of an antioxidant (Antioxidant 1010) (based on the weight of the PLA/PMMA mixture) was added into the mixture. The result was added into the feed of the twin screw extruder to perform a blending process at a temperature of 230° C., and then molded by the injection molding machine to obtain the light diffusion film (17) with a thickness of 2 mm. The optical properties (including transparence, haze, and diffusion rate) of the light diffusion film (17) were measured and are shown in Table 2.

### Comparative Example 9

500 g of Polylactic acid resin and 5 g of an antioxidant (Antioxidant 1010) were mixed (in the absence of PMMA). The mixture was added into the feed of the twin screw extruder to perform a blending process at a temperature of 230° C., and then molded by the injection molding machine to obtain the light diffusion film (18) with a thickness of 2 mm. The optical properties (including transparence, haze, and diffusion rate) of the light diffusion film (18) were measured and are shown in Table 2.

TABLE 2

| | Com- | Com- | Com- | Com- | Com- | Com- | Com- | Com- | | | | | |
|---|---|---|---|---|---|---|---|---|---|---|---|---|---|
| | parative | parative | parative | parative | parative | parative | parative | parative | | | | | |
| | Exam- | Exam- | Exam- | Exam- | Exam- | Exam- | Exam- | Exam- | Exam- | Exam- | Exam- | Exam- | Exam- |
| | ple 2 | ple 3 | ple 4 | ple 5 | ple 6 | ple 7 | ple 8 | ple 9 | ple 5 | ple 6 | ple 7 | ple 8 | ple 9 |
| polyactic acid | 30/70 | 50/50 | 70/30 | 25/75 | 25/75 | 25/75 | 25/75 | 100/0 | 25/75 | 25/75 | 25/75 | 25/75 | 25/75 |
| resin/PMMA | | | | | | | | | | | | | |
| antioxidant | 0 | 0 | 0 | 0 | 0.2 | 0.6 | 1 | 1 | 1 | 1 | 1 | 1 | 1 |
| (wt %) | | | | | | | | | | | | | |
| light diffusion | 0 | 0 | 0 | 0 | 0 | 0 | 0 | 0 | 1 | 2 | 3 | 4 | 0.5 |
| agent (wt %) | | | | | | | | | (PS) | (PS) | (PS) | (silicone) | (TiO2) |
| transparence % | 80.4 | 85.1 | 87.6 | 90.5 | 91.2 | 91.0 | 91.9 | 90.48 | 71.5 | 60.3 | 54.4 | 59.1 | |
| haze % | 27.4 | 18.6 | 15.3 | 3.8 | 2.9 | 2.9 | 2.4 | 3.76 | 99.3 | 99.5 | 99.5 | 99.5 | |
| diffusion rate % | 4.3 | 3.4 | 2.7 | 2.3 | 2.4 | 2.3 | 2.5 | 2.5 | 60.5 | 81.8 | 95.1 | 89.1 | |

As shown in Table 2, the light diffusion film made by the composition of the disclosure (in the simultaneous presence of an antioxidant and light diffusion agent) had diffusion rates which were several times larger than that of the light diffusion film made by the composition in the absence of a crystal nucleus agent and/or light diffusion agent. Therefore, the bio-based material compositions of the disclosure are suitable to serve as raw material for light diffusion elements with improved illuminance uniformity.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A bio-based material composition, comprising:
90-99.9 parts by weight of polylactic acid resin;
0.1-10 parts by weight of a filler; and
0.1-10 parts by weight of a light diffusion agent.

2. The bio-based material composition as claimed in claim 1, wherein the filler comprises silica.

3. The bio-based material composition as claimed in claim 1, further comprising:
0.1-10 parts by weight of a crystal nucleus agent.

4. The bio-based material composition as claimed in claim 3, wherein the crystal nucleus agent comprises aromatic phosphoric acid ester, aromatic amide ester, aliphatic amide, maleic anhydride grafted (MAH) polymer, anhydride modified polyethylene, thermoplastic polyolefin elastomer, or combinations thereof.

5. The bio-based material composition as claimed in claim 1, wherein the light diffusion agent has a refractive index of between 1.4-2.7.

6. The bio-based material composition as claimed in claim 1, wherein the light diffusion agent has an average grain size of between 0.1-30 μm.

7. The bio-based material composition as claimed in claim 1, wherein the light diffusion agent comprises polystyrene, co-poly(methyl methacrylate-styrene), polymethylsilsesquioxane, silicone, BaSO₄, Al₂O₃, TiO₂, or combinations thereof.

8. The bio-based material composition as claimed in claim 1, wherein the polylactic acid resin has a molecular weight of between 70000-120000.

9. An optical device, comprising:
a light diffusion element, wherein the light diffusion element is made by the bio-based material composition as claimed in claim 1.

10. A bio-based material composition, comprising:
1-50 parts by weight of polylactic acid resin;
50-99 parts by weight of petroleum resin;
0.1-3 parts by weight of an antioxidant; and
0.1-5 parts by weight of a light diffusion agent.

11. The bio-based material composition as claimed in claim 10, wherein the light diffusion agent has a refractive index of between 1.4-2.7.

12. The bio-based material composition as claimed in claim 10, wherein the light diffusion agent has an average grain size of between 0.1-30 μm.

13. The bio-based material composition as claimed in claim 10, wherein the light diffusion agent comprises polystyrene, co-poly(methyl methacrylate-styrene), polymethylsilsesquioxane, silicone, BaSO₄, Al₂O₃, TiO₂, or combinations thereof.

14. The bio-based material composition as claimed in claim 10, wherein the polylactic acid resin has a molecular weight of between 70000-120000.

15. The bio-based material composition as claimed in claim 10, wherein the antioxidant comprises phenol antioxidant, phosphorus-containing antioxidant, sulfur-containing antioxidant, amine antioxidant, or combinations thereof.

16. The bio-based material composition as claimed in claim 10, wherein the petroleum resin comprises polymethyl methacrylate (PMMA), poly(ethylene terephthalate) (PET), or polyacrylonitrile (PAN).

17. The bio-based material composition as claimed in claim 10, wherein the petroleum resin has a molecular weight of between 90000-170000.

18. The bio-based material composition as claimed in claim 10, wherein the ratio of the polylactic acid resin and the petroleum resin is between 1:4 to 4:1.

19. An optical device, comprising:
a light diffusion element, wherein the light diffusion element is made by the bio-based material composition as claimed in claim 10.
